(19) United States
(12) Patent Application Publication
(10) Pub. No.: US 2010/0089263 A1
(43) Pub. Date: Apr. 15, 2010

(54) DOCTOR BLADE

(75) Inventors: Tsutomu Sato, Chiba (JP); Tatsuo Shigeta, Chiba (JP)

Correspondence Address: MARGER JOHNSON & MCCOLLOM, P.C., 210 SW MORRISON STREET, SUITE 400, PORTLAND, OR, 97204, US

(73) Assignee: THINK LABORATORY CO., LTD., Chiba (JP)

(21) Appl. No.: 11/997,307

(22) PCT Filed: Aug. 4, 2006
(86) PCT No.: PCT/JP2006/315487

§ 371 Date: Jan. 29, 2008

(30) Foreign Application Priority Data
Aug. 10, 2005 (JP) 2005-231793

(51) Int. Cl. B41F 9/10; C23C 18/12; B05D 3/02

(52) U.S. Cl. 101/169; 427/397.7

(57) ABSTRACT

Provided is a doctor blade for use with a gravure printing roll, which hardly causes fogging even when it is used for the gravure printing using aqueous ink at the same printing speed as that of the gravure printing using oil based ink, can upgrade the gravure printing using the aqueous ink to a practical level, and can have an extended service life. The doctor blade includes a doctor blade body having a distal end with a knife edge portion, for filling gravure cells with ink and scraping off surplus ink with the knife edge portion being brought into contact with a gravure printing roll through a relative movement of the doctor blade to the gravure printing roll, in which at least the knife edge portion of the doctor blade body is coated with a silicon dioxide film, and the silicon dioxide film is formed by using a perhydropolysilazane solution.

### TECHNICAL FILED

The present invention relates to a doctor blade for filling gravure cells with ink and scraping off surplus ink in gravure printing through a relative movement of the doctor blade to a gravure printing roll with a knife edge portion being brought into contact with the gravure printing roll. Stated more specifically, the present invention relates to a doctor blade which hardly causes fogging even when the doctor blade is used for the gravure printing using aqueous ink at the same printing speed as that of the gravure printing using oil based ink, can upgrade the gravure printing using aqueous ink to a practical level, and can have an extended service life.

### BACKGROUND ART

FIG. 4 illustrates a doctor apparatus in a related gravure printing machine. In FIG. 4, reference numeral 10 denotes a gravure printing roll and reference numeral 12 denotes the doctor blade of a doctor apparatus. The doctor apparatus supports the doctor blade 12, and moves the doctor blade relatively to the gravure printing roll 10 with a knife edge portion 14 of the distal end of the doctor blade 12 being brought into contact with the gravure printing roll 10, to thereby fill gravure cells with ink and scrape off surplus ink.

The doctor blade 12 slides horizontally slowly as shown by an arrow A during printing to prevent one point of the knife edge portion 14 of the doctor blade 12 from coming into contact with only one predetermined point in a longitudinal direction of the gravure printing roll 10 to attain uniform abrasion of a shape of the distal end. If the doctor blade 12 does not slide horizontally as shown by the arrow A during printing, the abrasion of the distal end of the doctor blade will not become uniform, several positions of the distal end will greatly wear down, the ink scrape-off function of those positions will be lost, and a straight line continuous in the circumferential direction of a printing plate and not existent on a print image, that is, a doctor streak will be printed at a large number of unexpected positions.

Patent Documents 1 to 19 are prior art documents related to the doctor blade. Most of them relate to improvements of durability of the doctor blade. Patent Document 17, which is aimed to eliminate fogging is not effective in the gravure printing using oil based ink. Patents Documents 20 and 21 relate to the improvement of the shape and holding structure of the doctor blade.

The technical improvement of fogging in the gravure printing using oil based ink has been attained. On the other hand, the technical improvement of fogging in the gravure printing using aqueous ink is not attained and not advanced to a practical level at all. Up till now, the gravure printing of photos inserted into soft package films, calendars, and magazines has been carried out by using oil based ink.
Patent Document 1: JP 61-12396 A
Patent Document 2: JP 62-227645 A
Patent Document 3: JP 62-238743 A
Patent Document 4: JP 62-503085 A
Patent Document 5: JP 63-25038 A
Patent Document 6: JP 63-116852 A
Patent Document 7: JP 63-246249 A
Patent Document 8: JP 3-007394 A
Patent Document 9: JP 4-012853 A
Patent Document 10: JP 4-070341 A
Patent Document 11: JP 4-070342 A
Patent Document 12: JP 4-296556 A
Patent Document 13: JP 6-039991 A
Patent Document 14: JP 7-276601 A
Patent Document 15: JP 8-164598 A
Patent Document 16: JP 9-254356 A
Patent Document 17: JP 10-337840 A
Patent Document 18: JP 62-005959 A
Patent Document 19: JP 63-094576 A
Patent Document 20: U.S. Pat. No. 5,638,751
Patent Document 21: U.S. Pat. No. 4,895,071
Patent Document 22: JP 2000-79775 A
Patent Document 23: JP 2001-089126 A
   24: JP 2002-105676 A
Patent Document
   25: JP 2003-197611 A
Patent Document 26: JP 2003-336010 A

### DISCLOSURE OF THE INVENTION

### Problems to be Solved by the Invention

As understood from the related documents, the improvement and modification of the doctor blade have been proposed only from the viewpoints of the improvement of abrasion resistance and durability, the extension of service life, and the elimination of a doctor streak. For example, when ink contains titanium white, the abrasion speed becomes relatively high and therefore, the main concern is how abrasion resistance is provided to extend the service life so as to cut the running cost of the doctor blade, which is a consumption article.

In the related art, there has been no case where the doctor blade is modified to eliminate fogging so as to attain the practical application of the gravure printing using aqueous ink. More than 50% of an organic solvent contained in oil based ink for the gravure printing using oil based ink volatilizes and contaminates the air. Accordingly, shift to the gravure printing using small amount of aqueous ink containing 5 to 10% of an alcohol is now attracting attention. However, fogging readily occurs during the gravure printing using aqueous ink markedly, and high-precision printing cannot be realized by any means.

Since the gravure printing is carried out in such a manner that the doctor blade is placed upright on a gravure printing roll to fill ink into cells and scrape off surplus ink, ink does not remain on a non-printing area theoretically. However, as a matter of fact, ink goes under the doctor blade and remains on the non-printing area, thereby causing fogging. The term “fogging” means a phenomenon that ink goes under the doctor blade, is left on the non-printing area of the printing plate and transferred to a material to be printed to contaminate an image as it is not dried completely before it is printed. This phenomenon occurs when the doctor blade wears down significantly due to a too fast printing speed or a large number of prints. Fogging occurs remarkably in a case of using aqueous ink and is a difficult problem to be solved. However, even when oil based ink is used, this phenomenon occurs.

The mechanism of fogging will be described hereinbelow. Assume that the gravure printing using oil based ink is carried out after a surface of a roll is buffed into a high-precision mirror surface to form cells, a protective layer such as a chromium plating layer is formed to provide printing resistance, and burrs of the plating are removed to obtain an extremely high-precision mirror surface. Also assume that the doctor blade has an edge capable of scraping off ink completely. In this case, the doctor blade can scrape off oil based ink completely so that the ink does not remain on the non-printing area of the printing plate at all for an initial short period of time.

However, in this step of scraping off ink, a lubricant does not exist between the doctor blade and the printing plate. Therefore, the relative friction coefficient between the doctor blade and the printing plate becomes large, and the abrasions of the doctor blade and the printing plate readily occur. As a result, the ink scrape-off function of the doctor blade deteriorates and the printing plate becomes rough immediately. Then, oil based ink goes under the doctor blade and remains on the non-printing area to cause the fogging. When no lubricant is existent between the doctor blade and the printing plate, friction force generated correlatively in the doctor blade and the non-printing area of the printing plate changes continuously in combination with the decentering of the printing roll, thereby generating vibration. Therefore, oil based ink goes under the doctor blade and remains on the non-printing area, and fogging occurs markedly.

Then, when the surface of the roll is buffed with a No. 2,000 to 3,000 grindstone into an extremely high-precision mirror surface to form cells, a protective layer for providing printing resistance is formed, for example, chromium plating is carried out, burrs are removed and the roll is polished manually with sandpaper so completely and uniformly that marks of the sandpaper remain, self-lubricity is provided to the printing plate. With this, the gravure printing using oil based ink is carried out without causing fogging.

The self-lubricity of the printing plate can be described as follows. When chromium plating for providing printing resistance to the printing plate is rubbed with sandpaper, marks of the sandpaper are formed on the non-printing area. The doctor blade moves relatively to the gravure printing roll with being brought into contact with the gravure printing roll, to thereby fill the gravure cells with ink and scrape off surplus ink. Then, an extremely small amount of the oil based ink entering the marks of the sandpaper goes under the doctor blade. The oil based ink going under the doctor blade and remaining on the marks of the sandpaper has a low content of a pigment and high contents of a resin and a solvent. When the oil based ink remaining on the marks of the sandpaper goes under the doctor blade, the resin and the solvent are existent between the doctor blade and the printing plate as lubricants.

Therefore, the relative friction coefficient between the doctor blade and the non-printing area of the printing plate is reduced, and the abrasion of the edge of the doctor blade and the abrasion of the printing plate are suppressed. As for an extremely small amount of the oil based ink remaining on the marks of the sandpaper, its surface area exposed to dry air is remarkably large because it is an extremely thin film. Accordingly, the solvent contained in the oil based ink volatizes in a very short period of time before it is transferred to the printing position at a printing speed of 110 to 130 m/min. As a result, the pigment and the resin are drawn into the bottoms of the marks of the sandpaper, slightly dried, and therefore not transferred to the material to be printed.

When the pigment and the resin drawn into the bottoms of the marks of the sandpaper and slightly dried are combined with oil based ink to be applied again, the pigment and the resin are impregnated with the solvent and become wet. Therefore, the pigment and the resin are not dried and accumulated at the bottoms of the marks of the sandpaper. As a result, fogging does not occur even when the printing time passes. However, when the printing speed is increased, the extremely small amount of oil based ink going under the doctor blade and remaining on the marks of the sandpaper formed on the non-printing area does not volatilize within a period of time during which the printing sheet is transferred to the printing position, resulting in causing fogging. The above is a reason why fogging does not occur when self-lubricity is provided to the printing plate in the gravure printing using oil based ink.

In contrast to this, the relationship between the cause and effect in the gravure printing using aqueous ink cannot be discussed the same as the relationship between the provision of self-lubricity to the printing plate and no occurrence of fogging. In the gravure printing using aqueous ink, another situation where fogging occurs is existent. When the gravure printing using aqueous ink is carried out after the surface of the roll is first buffed into an extremely high-precision mirror surface to form cells, and a protective layer for providing printing resistance is formed, for example, chromium plating is carried out, and burrs are removed to form an extremely high-precision mirror surface, the doctor blade can scrape off oil based ink in such a manner that oil based ink does not remain on the non-printing area of the printing plate for the initial short period of time like when the gravure printing using oil based ink is carried out as described above. However, since the relative friction coefficient between the doctor blade and the non-printing area of the printing plate is large, the abrasion of the doctor blade is large, the surface becomes rough immediately, the aqueous ink goes under the doctor blade and remains on the non-printing area, and fogging occurs markedly.

Then, when the surface of the roll is buffed with a No. 2,000 to 3,000 grindstone into an extremely high-precision mirror surface to form cells, a protective layer for providing printing resistance is formed, for example, chromium plating is carried out, burrs are removed and the printing roll is polished manually so completely and uniformly that the marks of the sandpaper remain to manufacture a printing roll like the gravure printing using oil based ink, self-lubricity is provided to the printing plate. However, fogging occurs markedly in the gravure printing using aqueous ink, and high-precision printing cannot be realized at all.

There are some complex causes for this reason. Since aqueous ink contains a pigment in an amount 30% larger than that of oil based ink, the aqueous ink remaining on the marks of the sandpaper and not scraped off by the doctor blade has a high content of the pigment, and the evaporation of water and the drying of the pigment have a much larger drying load than the volatilization of an organic solvent and the drying of the pigment. As a result, the aqueous ink is dried much slowly. Therefore, the aqueous ink going under the doctor blade is not completely dried in a very short time during which it is transferred to the printing position, particularly water bonded to the pigment and the resin is not easily evaporated, the pigment and the resin drawn into the bottoms of the marks of the sandpaper and slightly dried have lower affinity for water than their affinity for the solvent, the affinity of the pigment and the resin for the water and alcohol of the ink is attained slowly even when the pigment and the resin are mixed with aqueous ink to be applied by a finisher roll again, and the pigment and the resin accumulate at the bottoms of the marks of the sandpaper. Further, since a doctor blade made of carbon steel is used in the prior art, after printing of 20,000 m, the abrasion of the doctor blade becomes large, its edge is greatly recessed, and the thickness of the edge is reduced from 55 μm to about 100 μm. As a result, the ink scrape-off function greatly deteriorates and the amount of aqueous ink not scraped off by the doctor blade increases.

Thus, in the gravure printing using aqueous ink, forming the marks of the sandpaper on the non-printing area does not eliminate fogging but causes fogging though the forming the marks of the sandpaper provides self-lubricity to the printing plate. Therefore, in the gravure printing using aqueous ink, relative lubricity between the doctor blade and the printing plate may be increased by another means and fogging may be prevented without forming the marks of the sandpaper on the non-printing area of the printing plate.

In view of the points, the applicant of the present application has already proposed a doctor blade whose service life can be extended by forming a diamond-like carbon film on at least the knife edge portion of a blade body, which hardly causes fogging even at the same printing speed as that of the gravure printing using oil based ink when being used for the gravure printing using aqueous ink and which can upgrade the gravure printing using aqueous ink to a practical level (Patent Document 22).

Although the diamond-like carbon film has excellent performance, it cannot be said that the formation of the film is not always stable and has an economical problem, thereby making it difficult to put it to practical use. Then, the inventors of the present invention have kept on with their researches into an excellent film material as a substitute for the diamond-like carbon film and have found that a silicon dioxide film formed by using a perhydropolysilazane solution is equivalent to the diamond-like carbon film in terms of performance, has no economical problem and can be formed stably. The present invention has been accomplished based on this finding. Patent Documents 23 to 26 are presented as documents related to perhydropolysilazane.

### Means for Solving the Problem

To solve the above-mentioned problem, a doctor blade according to the present invention includes a doctor blade body including a distal end with a knife edge portion, for filling gravure cells with ink and scraping off surplus ink with the knife edge portion being brought into contact with a gravure printing roll through a relative movement of the doctor blade to the gravure printing roll, in which at least the knife edge portion of the doctor blade body is coated with a silicon dioxide film, and the silicon dioxide film is formed by using a perhydropolysilazane solution. The doctor blade body may be formed of a thin steel plated, a thin stainless steel plate, or a thin plastic plate.

The silicon dioxide film is formed by using a perhydropolysilazane solution. More specifically, the perhydropolysilazane solution is applied to at least the knife edge portion of the blade body to form a coating film having a predetermined thickness and the perhydropolysilazane coating film thus applied is then heated with superheated steam for a predetermined period of time to form a silicon dioxide film having a predetermined hardness.

Although the thickness of the coating film of the perhydropolysilazane solution changes according to the concentration of the perhydropolysilazane solution, the thickness of the silicon dioxide film after the heating process for forming a film is 0.1 to 5 μm, preferably 0.1 to 3 μm, and more preferably 0.1 to 1 μm. For example, when the concentration of the perhydropolysilazane solution is 20%, the thickness of the coating film of the perhydropolysilazane solution may be about 5 times larger than the thickness of the target silicon dioxide film.

The temperature of the superheated steam is higher than 100° C., preferably 300° C. or lower. When the doctor blade body is composed of a plastic plate, superheated steam having a temperature lower than the heat resistant temperature of the plastic plate may be used.

The period of time for heating process, which changes according to the temperature of the superheated steam, is sufficient to be about 5 minutes to 1 hour. The hardness of the formed silicon dioxide film is about 800 to 3,000 in terms of Vickers hardness.

The quality of the silicon dioxide film can be improved by washing the surface of the silicon dioxide film formed by the heating process with cold water or hot water. Normal temperature water may be used as the cold water and water heated at about 40 to 100° C. may be used as the hot water. The washing time is sufficient to be about 30 seconds to 10 minutes.

The method of applying the perhydropolysilazane solution may include spray coating, ink jet coating, meniscus coating, fountain coating, dip coating, rotational coating, roll coating, wire bar coating, air knife coating, blade coating, or curtain coating.

A known solvent may be used as the solvent, which dissolves the perhydropolysilazane. Examples of the solvent include benzene, toluene, xylene, ether, THF, methylene chloride, and carbon tetrachloride; and anisole, decalin, cyclohexane, cyclohexene, methyl cyclohexane, ethyl cyclohexane, limonene, hexane, octane, nonane, decane, mixture of alkanes having 8 to 11 carbon atoms, a mixture of aromatic hydrocarbons having 18 to 11 carbon atoms, a mixture of aliphatic and alicyclic hydrocarbons which contain 5 or more to 25 or less wt % of an aromatic hydrocarbon having 8 or more carbon atoms, solvesso, diisopropyl ether, methyl t-butyl ether, decahydronaphthalene, and dibutyl ether, which are disclosed by Patent Document 25.

Although the perhydropolysilazane solution prepared by dissolving perhydropolysilazane in the solvent is directly converted into silicon dioxide or by a heating process with superheated steam, a catalyst is preferably used to increase the reaction rate, shorten the reaction time, reduce the reaction temperature and improve the adhesion of the formed silicon dioxide film. A known catalyst such as an amine or palladium may be used. Specific examples of the catalyst include organic amines such as primary to tertiary linear aliphatic amines having 1 to 3 alkyl groups with 1 to 5 carbon atoms, primary to tertiary aromatic amines having 1 to 3 phenyl groups, pyridine and alicyclic amines obtained by substituting the nucleus of pyridine with an alkyl group such as methyl or ethyl as disclosed by the Patent Document 23. More preferred are diethylamine, triethylamine, monobutylamine, monopropylamine, and dipropylamine. The catalyst may be added to the perhydropolysilazane solution in advance or may be contained in a gaseous state into an atmosphere for heating with superheated steam.

The thickness of the silicon dioxide film is 0.1 to 5 μm, preferably 0.1 to 3 μm, and more preferably 0.1 to 1 μm.

It is preferred that the perhydropolysilazane solution be applied to at least the knife edge portion of the doctor blade body by the coating technique such as spray coating or ink jet coating to form a coating film having a predetermined thickness and the perhydropolysilazane coating film thus applied is then heated with superheated steam for a predetermined period of time to form a silicon dioxide film having a predetermined hardness.

### Effect of the Invention

Since the doctor blade of the present invention has a silicon dioxide film on at least the distal end of the doctor blade body as described above, the doctor blade which is relatively moved to the gravure printing roll with its knife edge portion being brought into contact with the gravure printing roll to scrape off surplus ink can have an extended service life while retaining a self-lubricating function and abrasion resistance and does not have any chance of gently damaging the printing plate.

According to the doctor blade of the present invention, even when the gravure printing using aqueous ink is carried out at a practical printing speed and a practical printing length (number of prints), fogging does not occur. When the doctor blade having a silicon dioxide film is used, the edge has high flatness and linearity, excellent wettability, and a flexible surface. As a result, the edge easily approaches aqueous ink existent on the marks of the sandpaper which are formed on the non-printing area of the printing plate and the amount of ink going under the doctor blade can be significantly reduced. Therefore, fogging can be effectively avoided.

When the gravure printing using aqueous ink is carried out at a practical printing speed in the prior art, fogging occurs. When the doctor blade of the present invention is used, the commercial use of the gravure printing using aqueous ink can be realized for the first time. Since the abrasion of the edge having an ink scrape-off function of the doctor blade of the present invention is about ⅕ with respect to the prior art product, the service life of the doctor blade can be extended 5 times longer than that of the prior art product, thereby making it possible to avoid the occurrence of fogging for a long time. In addition, the doctor blade does not need to be exchanged in a short period of time, and the maintenance of the doctor blade is easy.

Since the abrasion of the printing plate can be suppressed with the doctor blade of the present invention, the number of prints of the printing plate can be made double or more substantially, and the re-formation of the protective film, for example, the number of times of chromium plating can be halved.

### BRIEF DESCRIPTION OF THE DRAWINGS

FIG. 1 is a sectional view of a main part of a doctor blade according to an embodiment of the present invention.

FIG. 2 is a flow chart illustrating a process of manufacturing the doctor blade of the present invention.

FIG. 3 is a diagram showing a process of manufacturing the doctor blade of the present invention, in which the part (a) is a sectional view of a doctor blade body, the part (b) is a sectional view showing that a perhydropolysilazane coating layer is formed on a surface of the doctor blade body, and the part (c) is a sectional view showing that the perhydropolysilazane coating layer is converted into a silicon dioxide film by heating with superheated steam.

FIG. 4 is a schematic perspective view of a doctor apparatus of the related art.

### DESCRIPTION OF REFERENCE NUMERALS

10: a gravure printing roll, 12, 20: a doctor blade, 14, 22: a knife edge portion, 24: a doctor blade body, 25: a perhydropolysilazane coating layer, 26: a silicon dioxide film

### BEST MODE FOR CARRYING OUT THE INVENTION

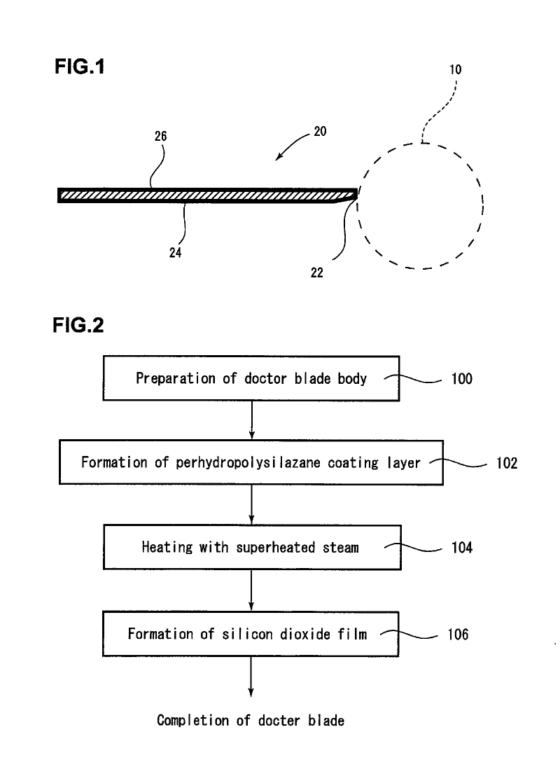

Hereinafter, an embodiment of the present invention will be described with reference to FIG. 1. FIG. 1 is a sectional view of a main part of a doctor blade according to an embodiment of the present invention. In FIG. 1, the position of the doctor blade 20 is adjusted in accordance with the diameter of a gravure printing roll 10 and has the function of scraping off surplus ink and filling ink into the gravure cells of the gravure printing roll 10 while a knife edge portion 22 is brought into contact with the gravure printing roll 10 at an angle. This doctor blade 20 is composed of a thin steel plate, stainless steel plate or plastic plate having high stiffness and flexibility, and consists of a doctor blade body 24 having the knife edge portion 22 at the distal end and a silicon dioxide film 26 having a thickness of 0.1 to 5 μm which is formed on the entire surfaces on both sides of the doctor blade body 24.

The doctor blade body 24 is made of hardened carbon steel. For example, an area having a length of 1,030 mm and a width of 1,200 μm of one end on one side of a very thin belt-like steel plate having a length of 1,030 mm, a width of 60 mm and a thickness of 150 μm is inclined such that the thickness of the distal end becomes 55 μm, and the inclined surface is hardened as the knife edge portion 22. The Vickers hardness of the doctor blade body 24 made of hardened carbon steel is about 600.

Preferably, the doctor blade 20 has the knife edge portion 22 on both sides. The silicon dioxide film 26 is formed by using a perhydropolysilazane solution. More specifically, the perhydropolysilazane solution is applied to at least the knife edge portion of the doctor blade body to form a coating film having a predetermined thickness and the perhydropolysilazane coating film thus applied is then heated with superheated steam for a predetermined period of time to form a silicon dioxide film having a predetermined hardness. The technique for applying the perhydropolysilazane solution is spray coating, ink jet coating, meniscus coating, fountain coating, dip coating, rotational coating, roll coating, wire bar coating, air knife coating, blade coating or curtain coating.

A known solvent may be used as the solvent, which dissolves the perhydropolysilazane. Examples of the solvent include benzene, toluene, xylene, ether, THF, methylene chloride and carbon tetrachloride; and anisole, decalin, cyclohexane, cyclohexene, methyl cyclohexane, ethyl cyclohexane, limonene, hexane, octane, nonane, decane, mixture of alkanes having 8 to 11 carbon atoms, a mixture of aromatic hydrocarbons having 18 to 11 carbon atoms, a mixture of aliphatic and alicyclic hydrocarbons which contain 5 or more to 25 or less wt % or less of an aromatic hydrocarbon having 8 or more carbon atoms, solvesso, diisopropyl ether, methyl t-butyl ether, decahydronaphthalene, and dibutyl ether, which are disclosed by the Patent Document 25.

Although the perhydropolysilazane solution prepared by dissolving perhydropolysilazane in the solvent is directly converted into silicon dioxide or by a heating process with superheated steam, a catalyst is preferably used to increase the reaction rate, shorten the reaction time, reduce the reaction temperature and improve the adhesion of the formed silicon dioxide film. A known catalyst such as an amine or palladium may be used. Specific examples of the catalyst include organic amines such as primary to tertiary linear aliphatic amines having 1 to 3 alkyl groups with 1 to 5 carbon atoms, primary to tertiary aromatic amines having 1 to 3 phenyl groups, pyridine and alicyclic amines obtained by substituting the nucleus of pyridine with an alkyl group such as methyl or ethyl as disclosed by the Patent Document 23. More preferred are diethylamine, triethylamine, monobutylamine, monopropylamine, and dipropylamine. The catalyst may be added to the perhydropolysilazane solution in advance or may be contained in a gaseous state into an atmosphere for heating with superheated steam.

The thickness of the silicon dioxide film is 0.1 to 5 μm, preferably 0.1 to 3 μm, and more preferably 0.1 to 1 μm.

It is preferred that the perhydropolysilazane solution be applied to at least the knife edge portion of the doctor blade body by the coating technique such as spray coating or ink jet coating to form a coating film having a predetermined thickness and the perhydropolysilazane coating film thus applied is then heated with superheated steam for a predetermined period of time to form a silicon dioxide film having a predetermined hardness.

Although the thickness of the coating film of the perhydropolysilazane solution changes according to the concentration of the perhydropolysilazane solution, the thickness of the silicon dioxide film after the heating process for forming a film is 0.1 to 5 μm, preferably 0.1 to 3 μm, and more preferably 0.1 to 1 μm. For example, when the concentration of the perhydropolysilazane solution is 20%, the thickness of the coating film may be about 5 times the thickness of the target silicon dioxide film.

The temperature of the superheated steam is higher than 100° C., preferably 300° C. or lower. When the doctor blade body is composed of a plastic plate, superheated steam having a temperature lower than the heat resistant temperature of the plastic plate may be used.

The period of time for heating process, which changes according to the temperature of the superheated steam, is sufficient to be about 5 minutes to 1 hour. The hardness of the formed silicon dioxide film is about 800 to 3,000 in terms of Vickers hardness.

The quality of the silicon dioxide film can be improved by washing the surface of the silicon dioxide film formed by the heating process with cold water or hot water. Normal temperature water may be used as the cold water and water heated at about 40 to 100° C. may be used as the hot water. The washing time should be about 30 seconds to 10 minutes.

The surface roughness (Ra) of the silicon dioxide film 26 is 0.03 μm to 0.04 μm, and the surface roughness (Ra) of the Cr plating film as a hard film is 0.03 μm to 0.04 μm.

Since the both sides of the edge are covered with the silicon dioxide film, the doctor blade 20 of the present invention is harder and has higher abrasion resistance and longer service life than a ceramic doctor. For the practical application of the gravure printing using aqueous ink, a high-definition print image may be realized by changing the number of screen lines from 175 lines/inch-meter to 300 lines/inch-meter to shorten the water evaporation time, the abrasion of the doctor blade and the abrasion of the printing plate may be suppressed, and aqueous ink which hardly causes fogging may be used. The printing plate may be mirror finished to reduce the surface roughness of the printing plate as much as possible after the printing plate is formed and plated with chromium.

Mirror finishing the printing plate means that ink going under the doctor blade is removed almost completely and the self-lubricity of the printing plate is reduced. It is expected that the mirror finishing the printing plate will increase the friction coefficient between the doctor blade and the printing plate, thereby accelerating the abrasions of the doctor blade and the printing plate. However, in the doctor blade of the present invention, both sides of the edge made of hardened carbon steel or stainless steel are covered with a silicon dioxide film and reaction force is mainly carried by the silicon dioxide film having extremely large abrasion resistance and an extremely low friction coefficient to reduce a portion of reaction force of the end face of the hardened carbon steel edge or stainless steel edge having a large friction coefficient. Therefore, the friction coefficient of the entire doctor blade can be made small.

The end face of the hardened carbon steel edge or stainless steel edge sandwiched between the silicon dioxide films is not exposed because the silicon dioxide film is left even when being worn down, and does not slide over the printing plate with large friction when the silicon dioxide film is not existent. Since the end face of the hardened carbon steel or stainless steel edge sandwiched between the silicon dioxide films has lower abrasion resistance than that of the silicon dioxide film, it also wears down quickly when the abrasion of the silicon dioxide film proceeds.

Therefore, as the doctor blade of the present invention can avoid a big increase in the friction coefficient between the mirror finished printing plate and the abrasion resistance of the silicon dioxide film is extremely high, even when printing is carried out at a practical speed and a printing length, the ink shearing function of the edge of the doctor blade can be maintained well for a long time.

The doctor blade 20 of the present invention has a hardened carbon steel or stainless steel edge whose both sides are covered with the silicon dioxide film, higher abrasion resistance than that of a ceramic doctor blade, and a long service life, is free from the chipping of the edge and the formation of a doctor streak, and is highly reliable as a doctor. On the other hand, a ceramic doctor blade may experience the chipping of an edge and the formation of a doctor streak though the ceramic doctor blade rarely wears down and has a long service life.

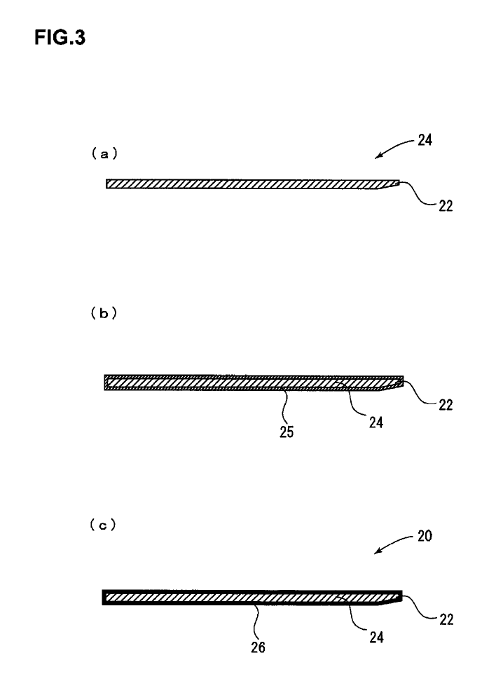

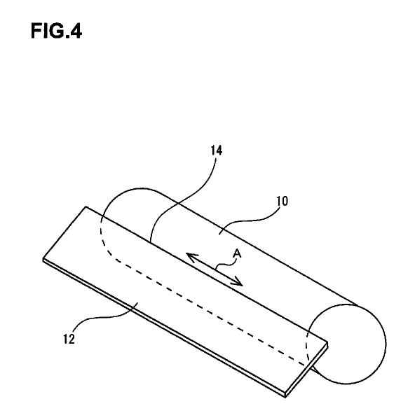

A description is subsequently given of the method of the present invention with reference to FIG. 2 and FIG. 3. The doctor blade body 24 having the knife edge portion 22 made of steel or stainless steel at the distal end is first prepared (FIG. 3(a) and step 100 of FIG. 2).

Then, the perhydropolysilazane coating layer 25 is formed on at least the knife edge portion 22 of the doctor blade body 24 (FIG. 3(b) and step 102 of FIG. 2). To form the perhydropolysilazane coating layer 25, the perhydropolysilazane solution may be applied by spray coating or ink jet coating.

Further, the perhydropolysilazane coating layer 25 is heated with superheated steam to form the silicon dioxide film 26 (FIG. 3(c) and step 104 of FIG. 2).

A doctor blade 20 which hardly causes fogging can be obtained by covering the knife edge portion 22 with the silicon dioxide film 26. In the various processing conditions in the method of the present invention, it is needless to say that the description of the doctor blade of the present invention can be applied.

### Example

The present invention is described in detail by way of examples. However, it should be noted that the present invention should not be construed as limiting.

### Production Example 1

The silicon dioxide film of the present invention was formed as follows. A 20% dibutyl ether solution of perhydropolysilazane (product name: Aquamica NL120A-20, “Aquamica” is the registered trademark of AZ Electronic Materials Co., Ltd.) was applied to a doctor blade body made of carbon steel by HVLP spray coating. The thickness of the coating film uniformly formed on the doctor blade body was 1.0 μm. The doctor blade body coated with perhydropolysilazane was heated with superheated steam (200° C./100% RH) for 30 minutes to form a silicon dioxide film (thickness of 0.2 μm). The doctor blade of the present invention was thus completed. When the Vickers hardness of the surface of the doctor blade was measured, it was 2,500.

### Example 1

The suitable printing speed at which the occurrence of fogging could not be observed was investigated by carrying out the gravure printing using aqueous ink. As a result, the occurrence of fogging was not seen at a practical printing speed of 110 to 130 m/min which is the same as the speed of the gravure printing using oil based ink when the doctor blade of the present invention manufactured in Production Example 1 was used. In contrast to this, the occurrence of fogging was seen at a printing speed of 95 m/min when the prior art doctor blade composed of a very thin belt-like steel plate was used.

### Example 2

The doctor blade of the present invention manufactured in Production Example 1 was set and the gravure printing using aqueous ink (the aqueous ink was Aquapia White (trade name, containing titanium white) of Toyo Ink Mfg. Co., Ltd.) was carried out to print 28,000 m. When the amount of abrasion of the edge was measured, it was 187 μm. This means that the amount of abrasion is 67 μm with respect to a printing ink was carried out with a doctor blade composed of a very thin belt-like steel plate of the prior art to print 20,000 m. When the amount of abrasion of the edge was measured, it was 660 μm. This means that the amount of abrasion is 330 μm based on a printing length of 10,000 m. When the abrasion and recession of the edge of the doctor blade in the gravure printing using aqueous ink become equal to those of the gravure printing using oil based ink, fogging appears markedly.

### Example 3

The doctor blade of the present invention manufactured in Production Example 1 was set and the gravure printing using aqueous ink (the aqueous ink was Aquaecole (trade name) of Toyo Ink Mfg. Co., Ltd.) was carried out to print 50,000 m. When the amount of abrasion of the printing plate was measured, the printing area of the printing roll had an abrasion of 2 μm and the non-printing area had an abrasion of 0 to 1 μm. In contrast to this, the gravure printing using aqueous ink was carried out with a doctor blade composed of a very thin belt-like steel plate of the prior art to print 50,000 m. When the amount of abrasion of the printing plate was measured, the image portion of the printing roll had an abrasion of 4 μm and the non-printing area had an abrasion of 2 μm.

### Example 4

The annealing hardness of the doctor blade of the present invention manufactured in Production Example 1 was measured. Since the hardening temperature of the doctor blade body made of carbon steel was higher than 300° C., the doctor blade body was not annealed by heating at the time of forming a film, a Vickers hardness of 2,500 was maintained, and the hardness of the doctor blade body was not too low as a substrate for the silicon dioxide film. When the doctor blade body is made of stainless steel, it cannot be hardened but is sufficiently hard.

### Example 5

The relationship among the surface roughness of the printing plate of the printing roll, the wettability of the printing plate and fogging of the doctor blade of the present invention manufactured in Production Example 1 was investigated. As the surface roughness of the printing plate becomes higher, the apparent wettability becomes lower, the contact angle of a droplet becomes larger and fogging appears more markedly. It has been found that the silicon dioxide film has an extremely flat surface, a smaller contact angle than carbon steel, nickel, and ceramics, and higher wettability.

1. A doctor blade comprising a doctor blade body comprising a distal end with a knife edge portion, for filling gravure cells with ink and scraping off surplus ink with the knife edge portion being brought into contact with a gravure printing roll through a relative movement of the doctor blade to the gravure printing roll, wherein at least the knife edge portion of the doctor blade body is coated with a silicon dioxide film and the silicon dioxide film is formed by using a perhydropolysilazane solution.

2. The doctor blade according to claim 1, wherein the silicon dioxide film has a thickness of 0.1 to 5 μm.

3. A method of manufacturing a doctor blade, comprising the steps of:
preparing a doctor blade body including a distal end with a knife edge portion; and
forming a silicon dioxide film on at least the knife edge portion of the doctor blade body,
wherein the silicon dioxide film is formed by using a perhydropolysilazane solution.

4. The method of manufacturing a doctor blade according to claim 3, wherein the step of forming a silicon dioxide film comprises:
a forming process for forming a coating film involving applying the perhydropolysilazane solution to at least the knife edge portion of the doctor blade body to form the coating film having a predetermined thickness; and
a heating process for forming a film involving heating the coating film applied with the perhydropolysilazane solution with superheated steam for a predetermined period of time to form a silicon dioxide film having a predetermined hardness.

5. The method of manufacturing a doctor blade according to claim 4, further comprising a step of washing a surface of the silicon dioxide film formed by the heating process with cold water or hot water.

6. The method of manufacturing a doctor blade according to claim 3, wherein the silicon dioxide film has a thickness of 0.1 to 5 μm.

7. The method of manufacturing a doctor blade according to claim 4, wherein the silicon dioxide film has a thickness of 0.1 to 5 μm.

8. The method of manufacturing a doctor blade according to claim 5, wherein the silicon dioxide film has a thickness of 0.1 to 5 μm.
